(19) United States
(12) Patent Application Publication
(10) Pub. No.: US 2026/0064668 A1
(43) Pub. Date: Mar. 5, 2026

(54) SYSTEM AND METHOD FOR AUGMENTING LARGE LANGUAGE MODELS WITH GRAPH KNOWLEDGE GENERATED BY UNIVERSAL MODELING OF DATASETS

(71) Applicant: ORACLE INTERNATIONAL CORPORATION, Redwood Shores, CA (US)

(72) Inventors: Kalyan Beemanapalli, Danville, CA (US); Gustavo Alejandro Cruz Silva, Guadalajara (MX); Huanxin Ding, San Carlos, CA (US); Luxi Wang, Seattle, WA (US); Zijiao Wang, Belmont, CA (US)

(21) Appl. No.: 19/302,931

(22) Filed: Aug. 18, 2025

Related U.S. Application Data
(60) Provisional application No. 63/690,590, filed on Sep. 4, 2024.

(51) Int. Cl. G06F 16/242; G06F 16/28

(52) U.S. Cl. CPC G06F 16/2423; G06F 16/243; G06F 16/288

(57) ABSTRACT

Embodiments described herein are generally related to data analytics environments, and are particularly directed to systems and methods for augmenting large language models with graph knowledge generated by universal modelling of datasets. In accordance with an embodiment, a method for augmenting large language models with graph knowledge generated by universal modeling of datasets, is provided. The method can provide, by a computer including one or more processors, access to a data analytics environment. The method can create a graph schema associated with a dataset of the data analytics environment. The method can receive a query associated with the dataset of the data analytics environment. The method can receive, at a large language model, a parsed version of the query, together with the graph schema. The method can, based upon the received parsed query and the graph schema, generate, by the large language model, a graph query.

### CLAIM OF PRIORITY AND CROSS-REFERENCE TO RELATED APPLICATIONS

This application claims the benefit of priority to U.S. Provisional Patent Application titled “SYSTEM AND METHOD FOR AUGMENTING LARGE LANGUAGE MODELS WITH GRAPH KNOWLEDGE GENERATED BY UNIVERSAL MODELING OF DATASETS”, Application No. 63/690,590, filed Sep. 4, 2024; and is related to U.S. Patent Application titled “SYSTEM AND METHOD FOR GENERATING A NETWORK GRAPH FROM ANALYTIC ARTIFACTS IN AN ANALYTICS ENVIRONMENT”, application Ser. No. 17/697,705, filed Mar. 17, 2022, and subsequently published as U.S. Patent Application Publication No. 2023/0297586 on Sep. 21, 2023; each of which above applications together with the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for augmenting large language models with graph knowledge generated by universal modelling of datasets.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

### SUMMARY

Embodiments described herein are generally related to data analytics environments, and are particularly directed to systems and methods for augmenting large language models with graph knowledge generated by universal modelling of datasets.

In accordance with an embodiment, a method for augmenting large language models with graph knowledge generated by universal modelling of datasets, is provided. The method can provide, by a computer including one or more processors, access to a data analytics environment. The method can create a graph schema associated with a dataset of the data analytics environment. The method can receive a query associated with the dataset of the data analytics environment. The method can receive, at a large language model, a parsed version of the query, together with the graph schema. The method can, based upon the received parsed query and the graph schema, generate, by the large language model, a graph query.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a system for augmenting large language models with graph knowledge generated by universal modelling of datasets, in accordance with an embodiment.

FIG. 12 illustrates a system for augmenting large language models with graph knowledge, in accordance with an embodiment.

FIG. 13 illustrates a system for augmenting large language models with graph knowledge, in accordance with an embodiment.

FIG. 14 illustrates a system for augmenting large language models with graph knowledge, in accordance with an embodiment.

FIG. 15 illustrates a system for augmenting large language models with graph knowledge, in accordance with an embodiment.

FIG. 16 illustrates a screenshot produced by a system for augmenting large language models with graph knowledge, in accordance with an embodiment.

FIG. 17 illustrates a screenshot produced by a system for augmenting large language models with graph knowledge, in accordance with an embodiment.

FIG. 18 illustrates a screenshot produced by a system for augmenting large language models with graph knowledge, in accordance with an embodiment.

FIG. 19 is a flowchart of a method for augmenting large language models with graph knowledge generated by universal modelling of datasets, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

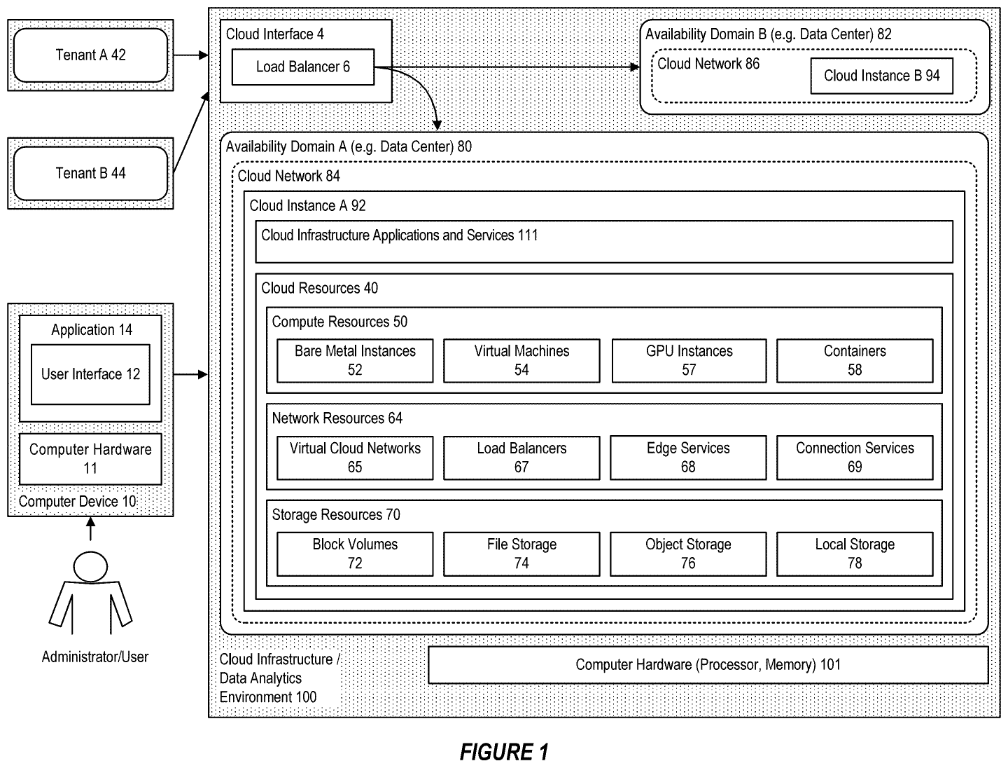

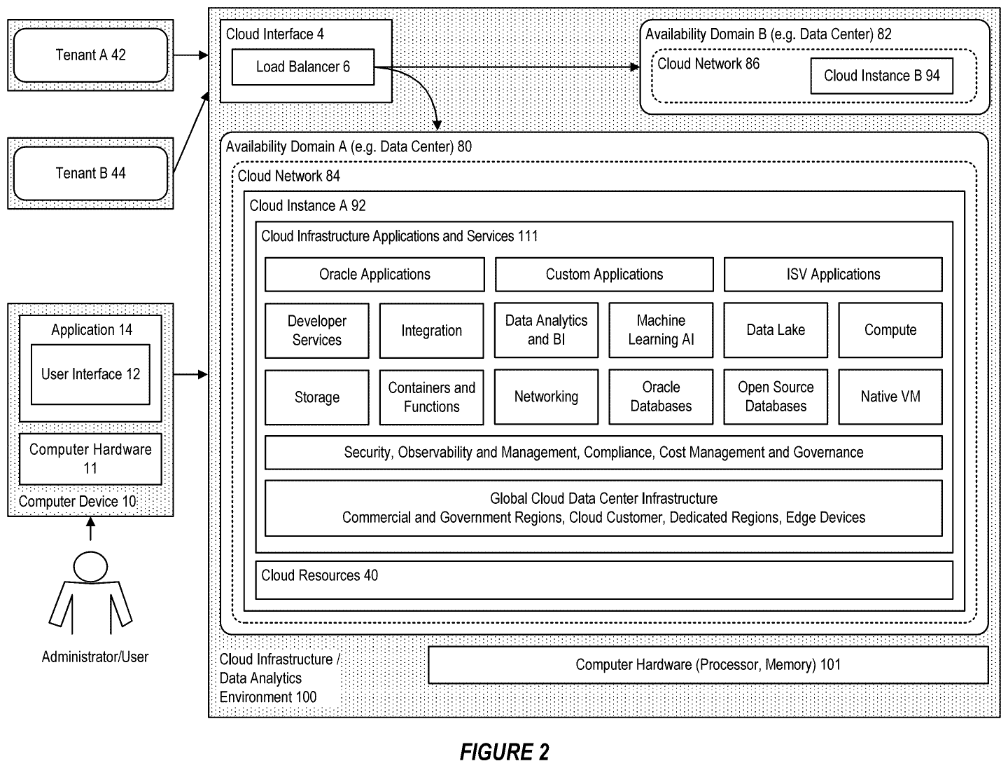

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

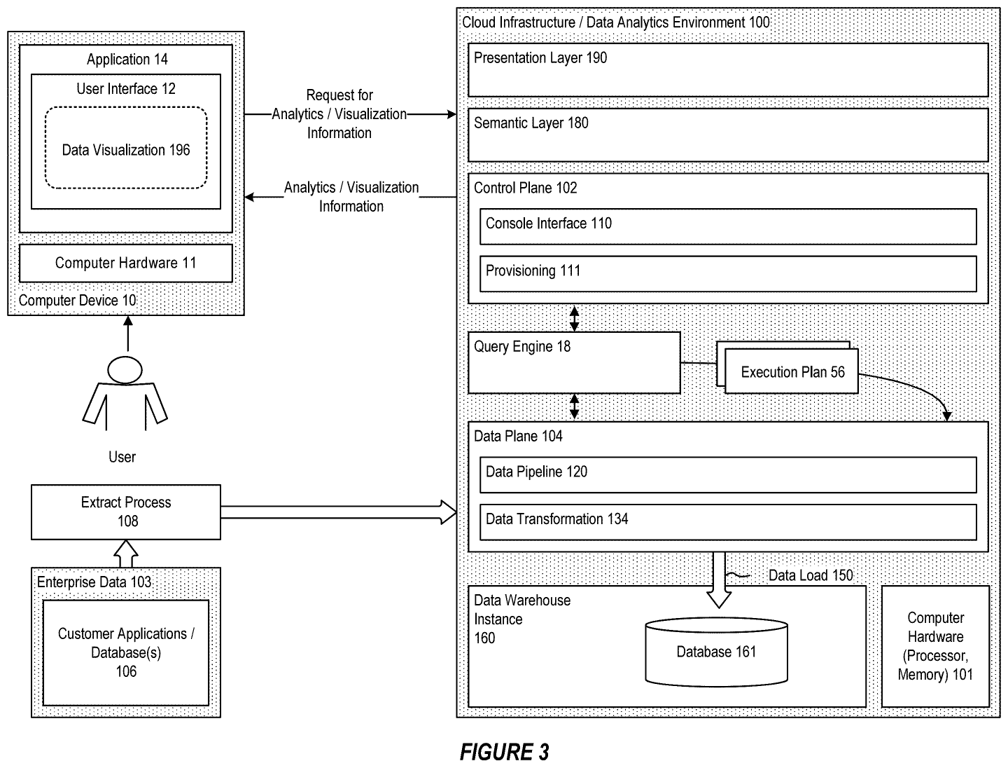

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

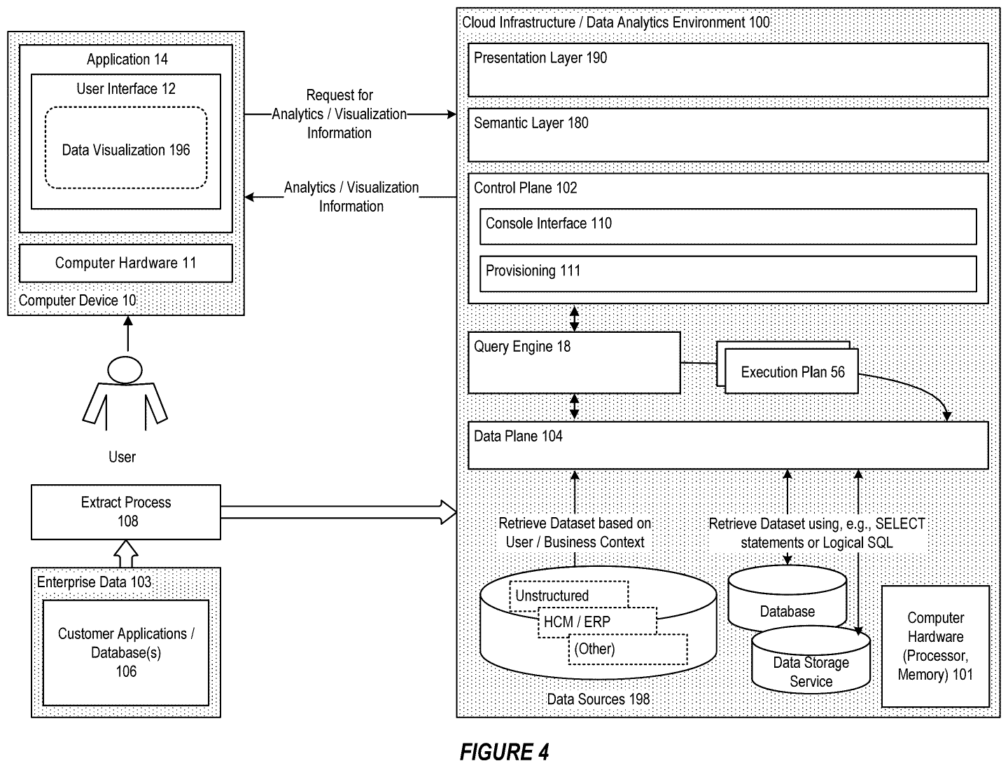

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

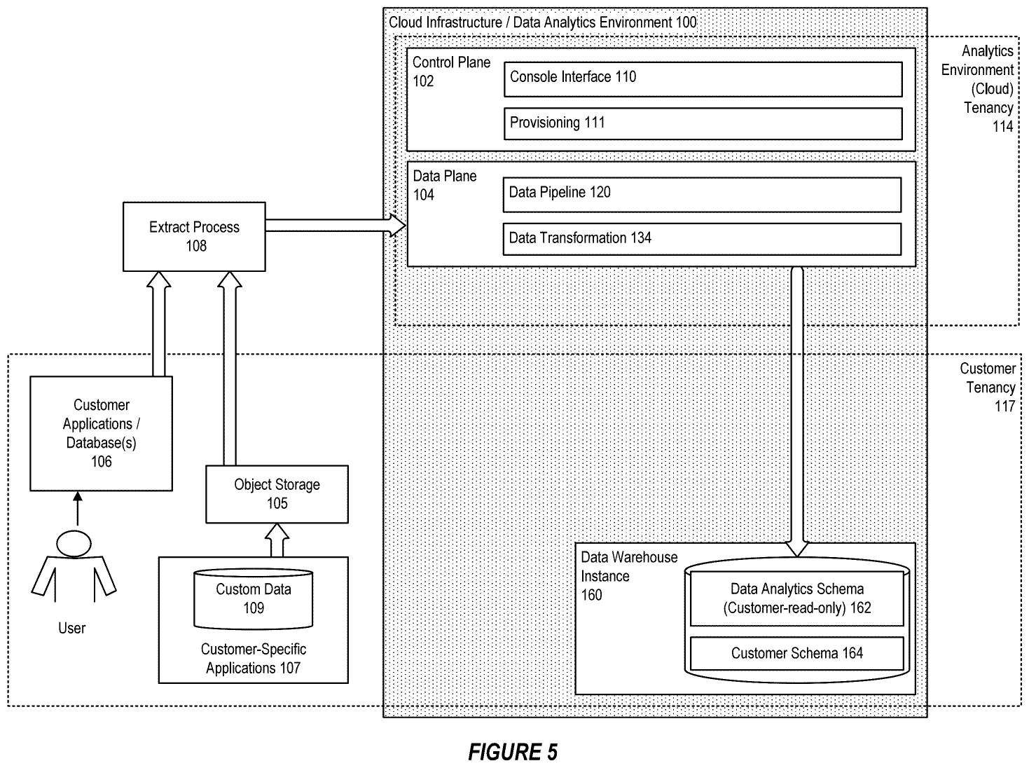

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

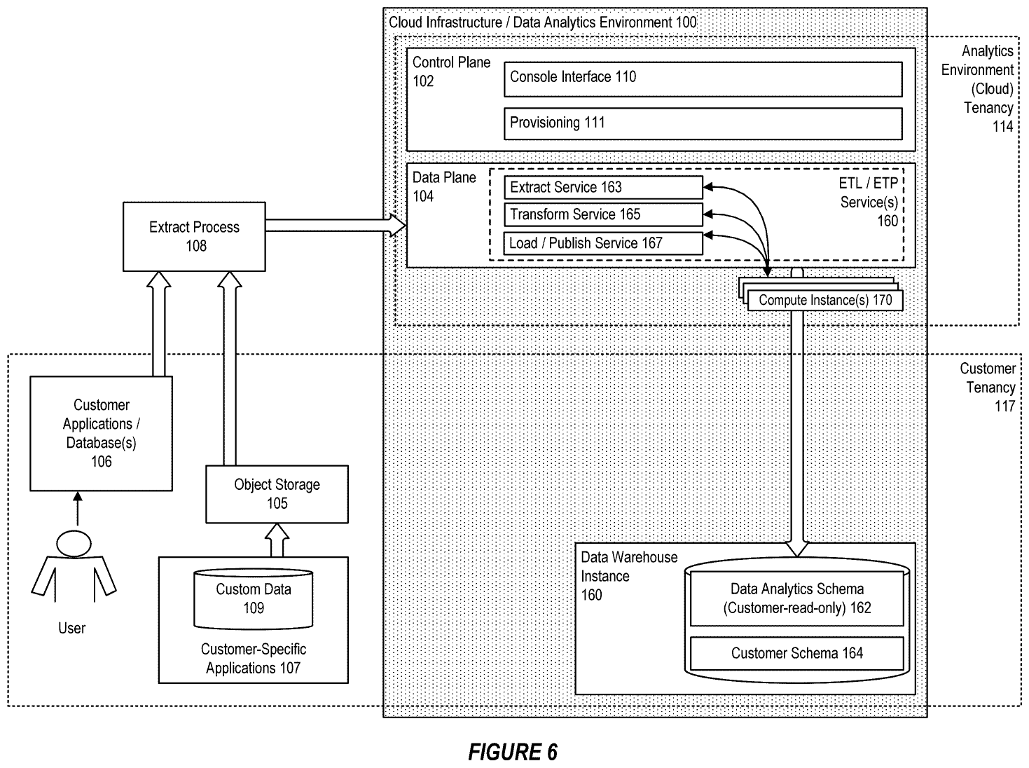

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

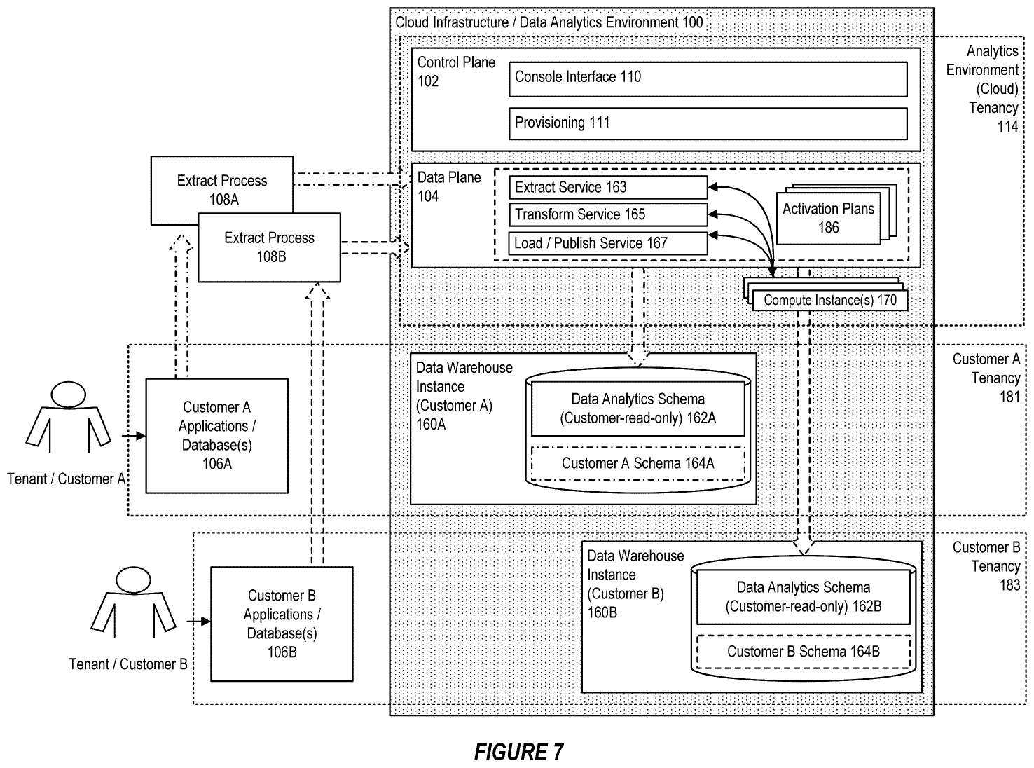

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

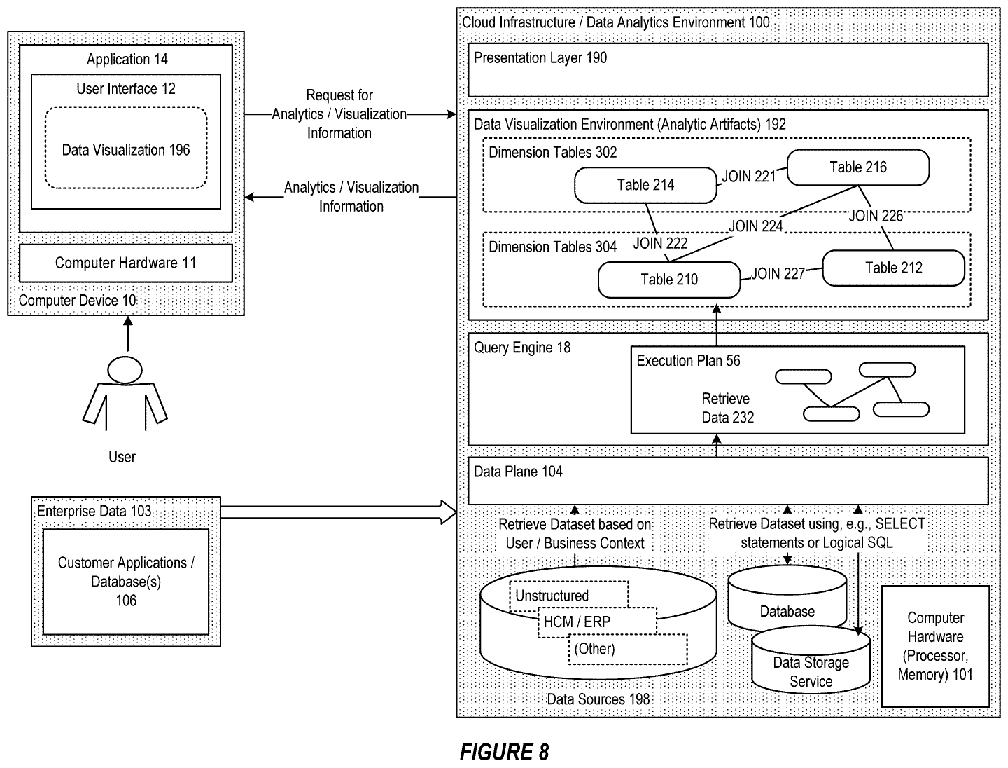

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210, 212, 214, 216, or joins 221, 222, 224, 226, 227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

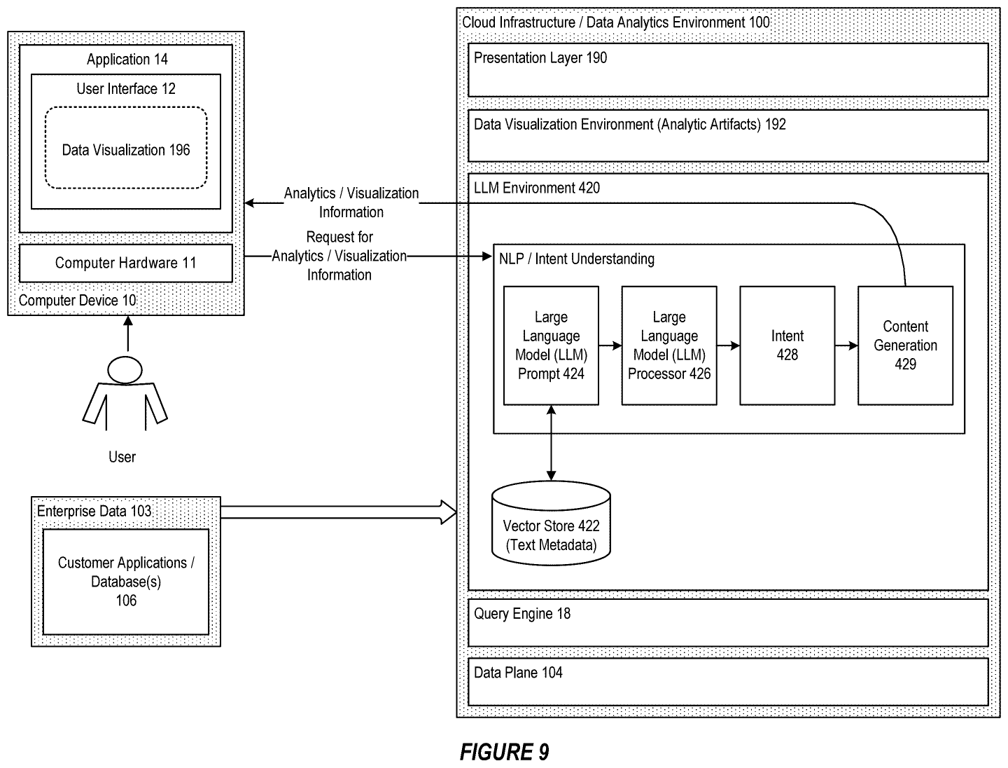

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

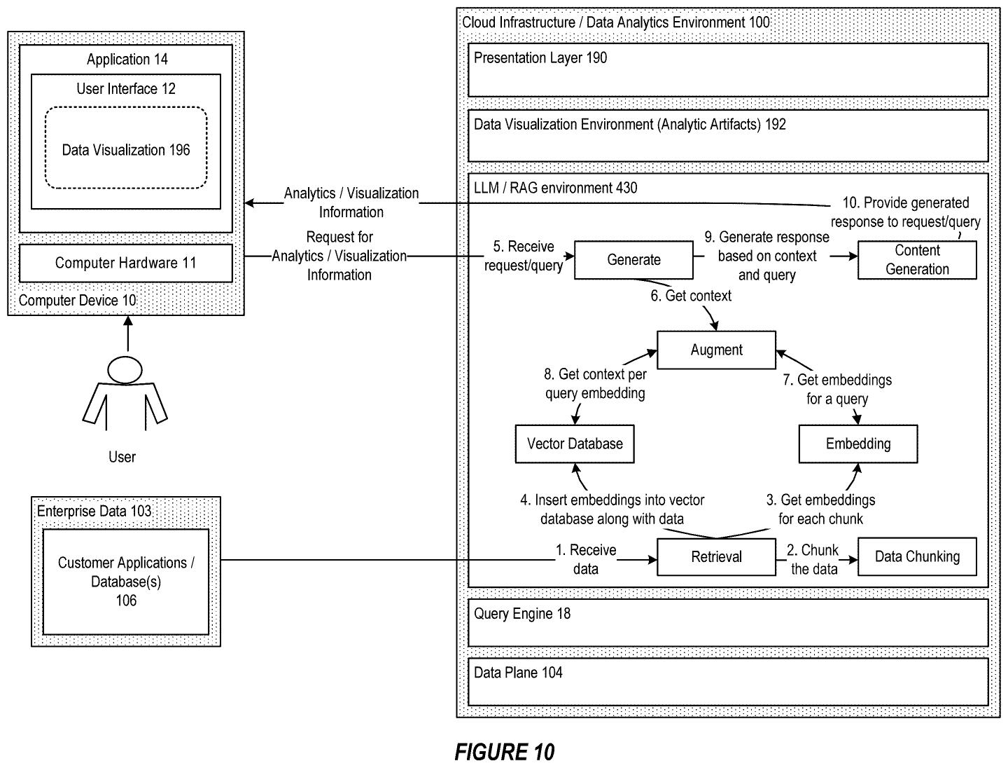

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

Augmenting LLMs with Graph Knowledge

In accordance with an embodiment, instead of fine tuning LLMs (large language models) on complex business intelligence data modelling techniques, the systems and methods described herein can utilize a universal data modeling technique using graph technologies. Applications, such as retrieval-augmented generation (RAG) applications can then be built on top of and utilize the graph model.

In accordance with an embodiment, augmenting LLMs with external knowledge from datasets (e.g., private datasets) is an effective methodology to build RAG applications. The presently disclosed systems and methods can model a dataset using graph technologies to capture relationships between entities in natural language. These relationships and properties of the entities in the dataset can be used to augment LLMs. From this, various RAG applications can be built. Examples of three such RAG applications include: summarizing and narrating data behind a visualization in natural language; an assistant that helps users (e.g., analytics users) interact with datasets (e.g., private datasets belonging to or owned by the user or to which the user has access to) in natural language; and/or a natural language interface for retrieving relationships between various analytics artifacts.

In accordance with an embodiment, the systems and methods empower data analytics environments to build RAG applications for various use cases that leverage the power of LLMs. This allows users of such environment to interact with datasets (e.g., private datasets) using natural language inputs.

Traditionally, business intelligence (BI) applications utilize a processing of relational data to generate reports and visualizations to the users. Modeling data using graph technologies helps discover deeper insights into data.

In accordance with an embodiment, such a generic data modeling framework can be utilized to convert various data schemas into a graph schema. In accordance with an embodiment, the modeling is not just limited to an entire dataset. Instead, any data in tabular format (e.g., data behind a visualization) can be modeled as graph schema. In accordance with an embodiment, the systems and methods can support RAG applications that leverage relationship data between the entities in the dataset to augment LLMs.

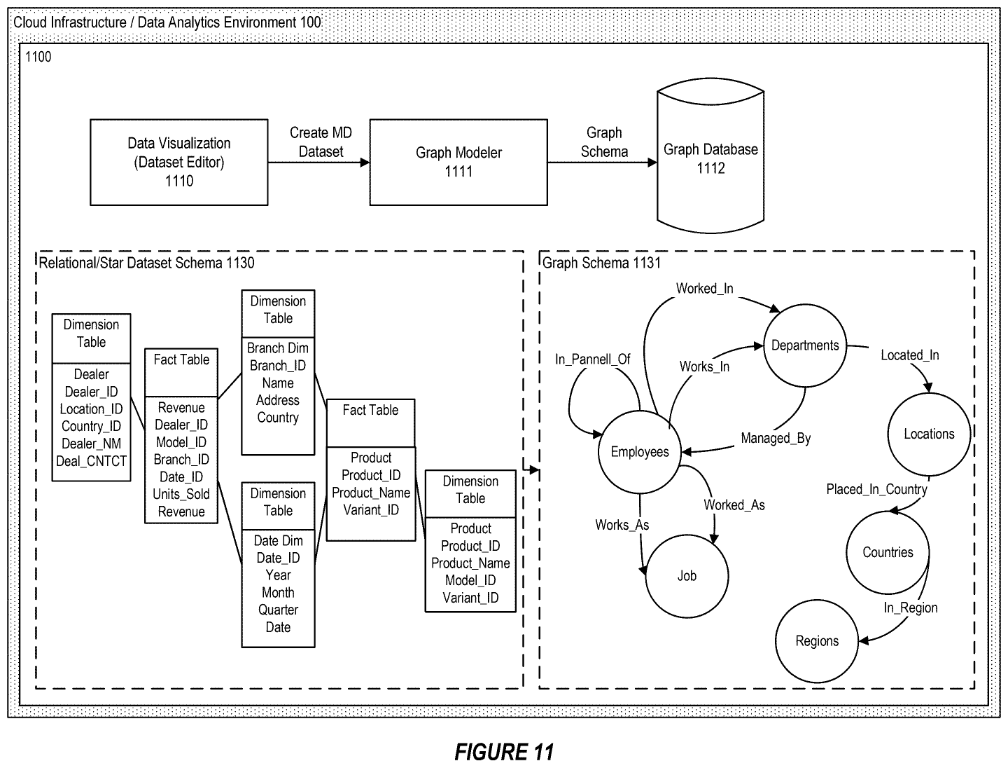

FIG. 11 illustrates a system for augmenting large language models with graph knowledge generated by universal modelling of datasets, in accordance with an embodiment.

In accordance with an embodiment, FIG. 11 illustrates a system for converting existing datasets into a graph schema, which can then be stored at a graph database.

In accordance with an embodiment, a process 1100 can begin at a data visualization (e.g. a dataset editor) environment 1110. There, steps can be taken, e.g., by a user of the environment to create a dataset, such as a multidimensional (MD) dataset. This MD dataset can comprise a schema, or format, such as a star schema or a snowflake and galaxy schema. This dataset can be fed into a graph modeller 1111, which can then convert the schema of the MD dimensional dataset into a graph schema. The graph schema can be fed into and/or saved at a graph database 1112.

In accordance with an embodiment, such a conversion is shown in FIG. 11 where a relational/star dataset schema 1130, which comprises several dimension and fact tables joined along edges shown in the figure, is converted into a graph schema 1131. This graph schema, as shown, comprises various determined nodes connected by determined edges together with relational data stored along each edge which describes a relationship between the connected nodes.

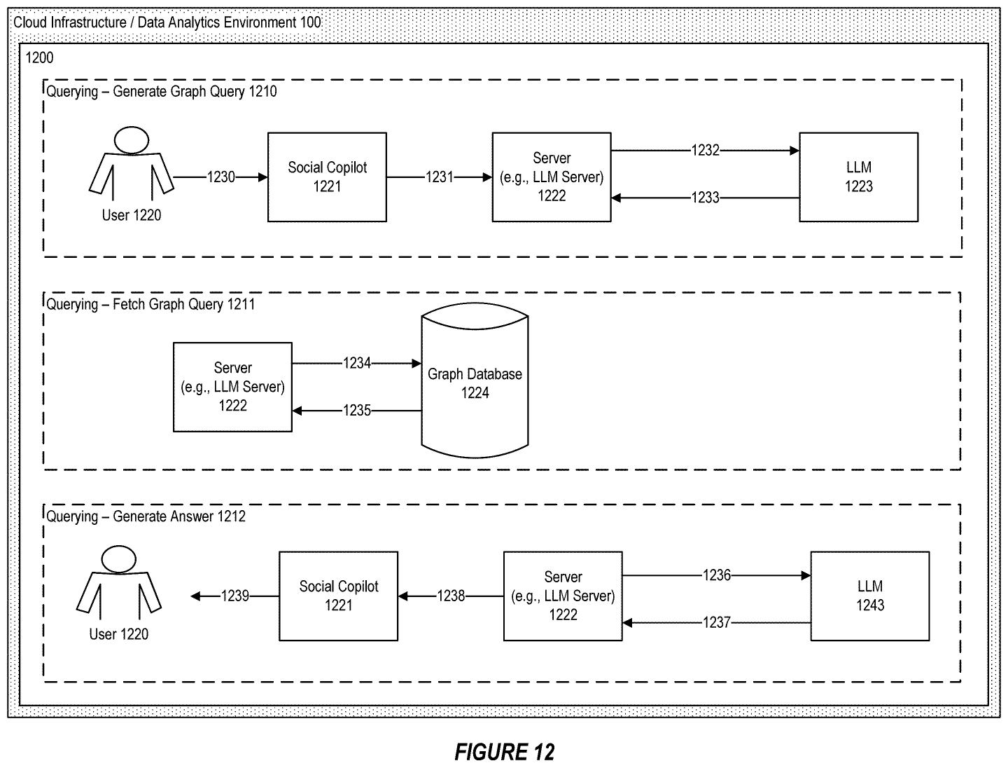

FIG. 12 illustrates a system for augmenting large language models with graph knowledge generated by universal modelling of datasets, in accordance with an embodiment.

In accordance with an embodiment, FIG. 12 illustrates how querying 1200 takes place in three phases, namely a generate graph query phase 1210, a querying phase 1211, and an answer phase 1212. In a first query phase 1210, the system can generate a graph query. This can begin with a user 1220 interacting 1230 with an application 1221, such a social copilot. This interaction can comprise, for example, submitting a query in natural language. user inputs a query in natural language to a user interface at the social copilot. For example, a user can submit a query such as “what is the relationship between the employee dataset and the customer dataset” ?

In accordance with an embodiment, the application can parse the query and pass 1231 it to a server, such as an LLM server 1222. The LLM server can transmit 1232 the parsed query to an LLM together with the generated graph schema. The LLM can then, based upon the received query and the graph schema, generate a graph query, which can be returned to the server 1222.

In accordance with an embodiment, in a second phase 1211, the server 1222 can execute 1234 the generated graph query against a graph database 1224 and can receive 1235 results of the executed graph query.

In accordance with an embodiment, in a third phase 1212, the server, upon receiving the results of executing the generated graph query against the graph database, can feed 1236 the results back to an LLM 1243 (which can be the same, or a different LLM, as 1223), which can then return 1237 the results back to the server in a natural language format. The server can return 1238 the natural language results back to the application 1221, which can display 1239 the results back to a user.

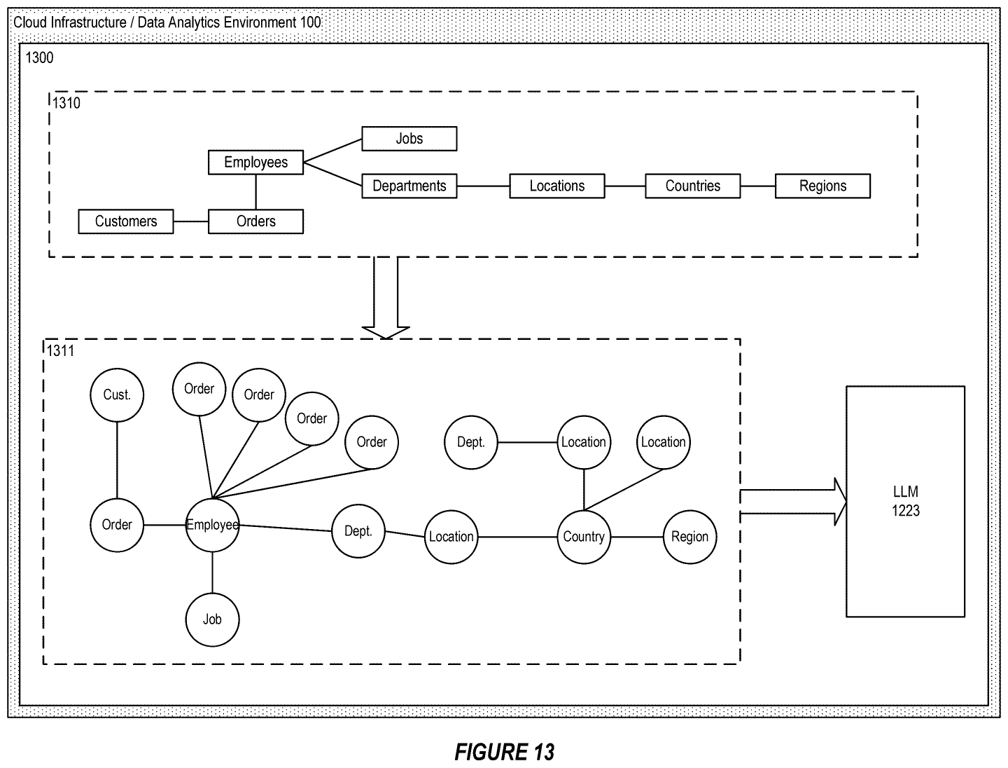

FIG. 13 illustrates a system for augmenting large language models with graph knowledge generated by universal modelling of datasets, in accordance with an embodiment.

In accordance with an embodiment, FIG. 13 illustrates a process 1300 where a dataset which comprises a relational schema 1310 can be converted into a graph schema 1311, which can then be transmitted to an LLM 1223 to be used for generating graph queries and eventually answering queries.

In accordance with an embodiment, traditional relational database schemas are not well equipped to answer natural language queries such as “what region does my employee work in?” since answering such a query would generally necessitate expensive join operations to take place between multiple datasets. With a graph schema, however, it is a much cheaper schema without the need to perform an expensive join. Using natural relationships in the graph schema to answer the query. Instead of performing expensive joins, a graph schema 1311 allows the query to just follow links instead of performing joins.

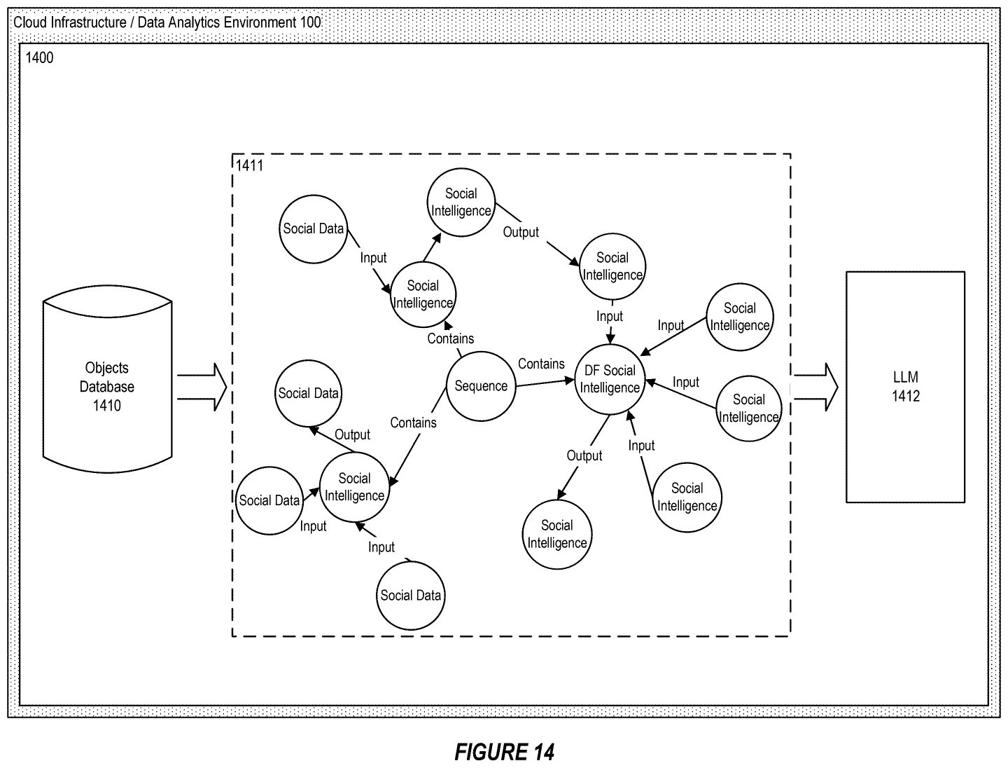

FIG. 14 illustrates a system for augmenting large language models with graph knowledge generated by universal modelling of datasets, in accordance with an embodiment.

In accordance with an embodiment, FIG. 14 illustrates a RAG application, such as for example a social copilot for use with a data lineage. A data lineage can utilize graph technologies and can provide a natural use case for RAG applications.

In accordance with an embodiment, an application 1400 can comprise objects, such as objects from an object database 1410, which are constructed into a graph schema 1411. This graph schema can trace a data lineage, e.g., between data inputs, outputs, and other links (such as for example “contains”) between nodes of the graph schema. This graph schema 1411 can be inputted into a large language model 1412 for use by the application or other purposes.

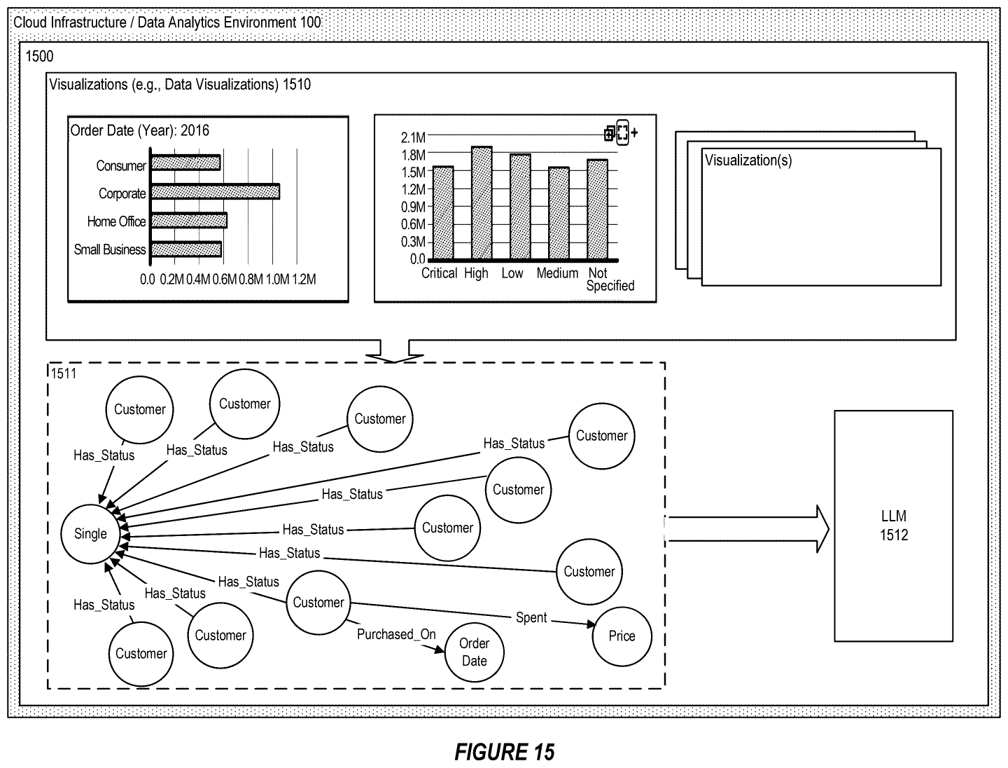

FIG. 15 illustrates a system for augmenting large language models with graph knowledge generated by universal modelling of datasets, in accordance with an embodiment.

In accordance with an embodiment, FIG. 15 illustrates a RAG application 1500, such as for example a social copilot that can be utilized to narrate or provide context for data visualizations 1510, or multiple data visualizations 1510. A RAG application, utilizing a generated graph schema 1511, can summarize a visualization in a natural language format/output utilizing an LLM 1512. Such a summarization can be data type sensitive—the generated narration can narrate trend details of a metric against, for example, a date column.

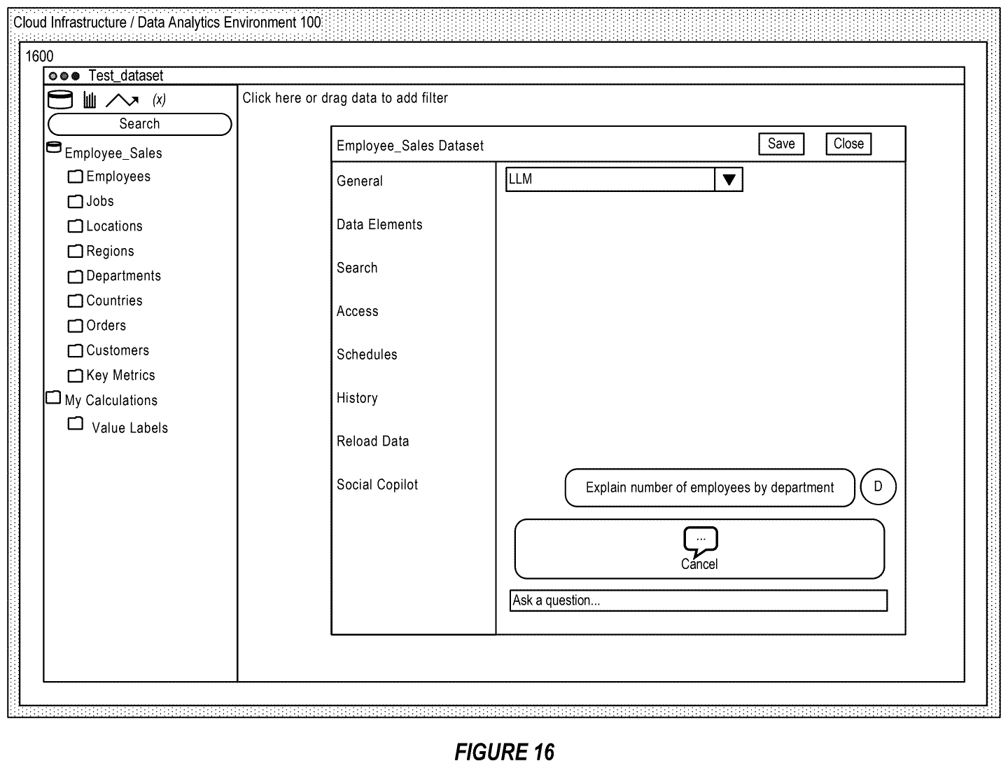

FIG. 16 illustrates a screenshot produced by a system for augmenting large language models with graph knowledge generated by universal modelling of datasets, in accordance with an embodiment.

In accordance with an embodiment, FIG. 16 illustrates a screenshot 1600 of, e.g., a RAG application utilizing the above-described systems and methods where a user can enter a natural langue query, such as “Explain number of employees by department”.

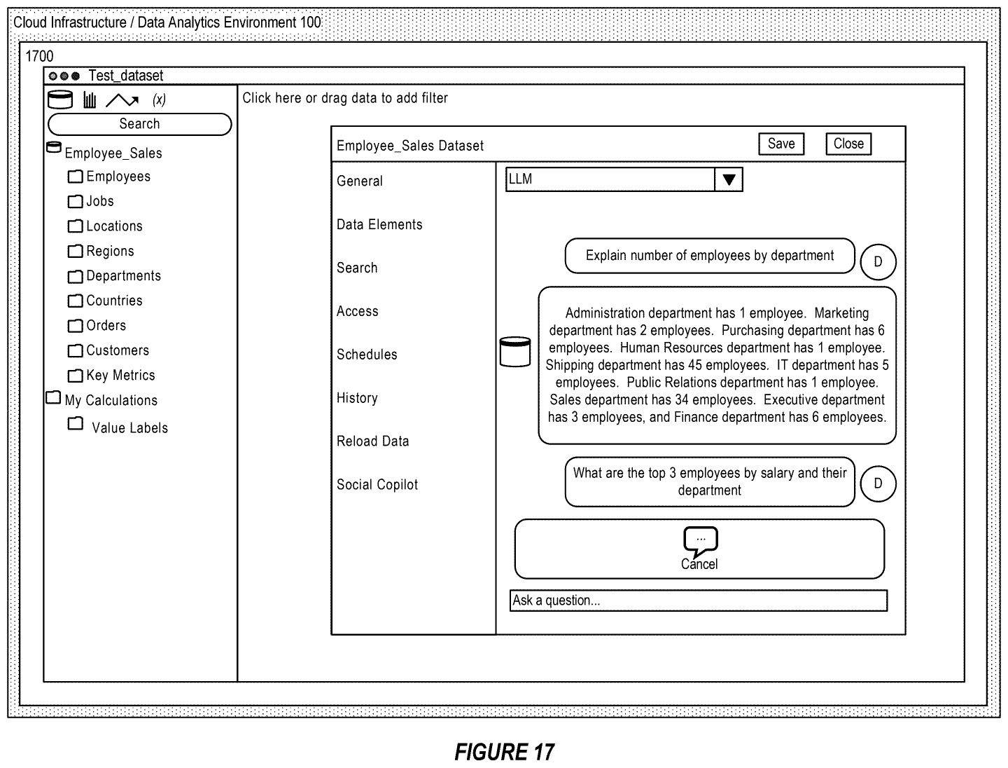

FIG. 17 illustrates a screenshot produced by a system for augmenting large language models with graph knowledge generated by universal modelling of datasets, in accordance with an embodiment.

In accordance with an embodiment, FIG. 17 illustrates a screenshot 1700 of, e.g., a RAG application utilizing the above-described systems and methods where the RAG application is responding to successive natural language queries, such as “Explain the number of employees by department”. The RAG application provides and displays a response, and can then receive an additional input. The RAG application can, responsive to such a request, provide a narration, in natural language, of the target visualization.

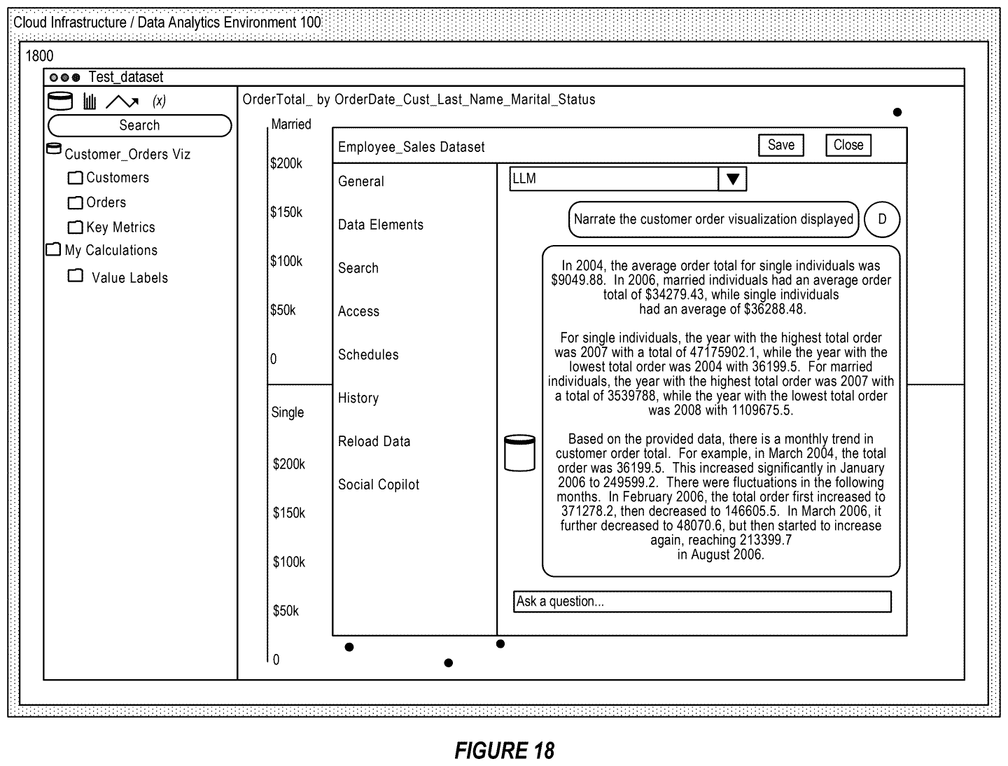

FIG. 18 illustrates a screenshot produced by a system for augmenting large language models with graph knowledge generated by universal modelling of datasets, in accordance with an embodiment.

In accordance with an embodiment, FIG. 18 illustrates a screenshot 1800 of, e.g., a RAG application utilizing the above-described systems and methods where the RAG application is responding to a natural language query of “Narrate Customer Orders Viz”. The RAG application can, responsive to such a request, provide a narration, in natural language, of the target visualization.

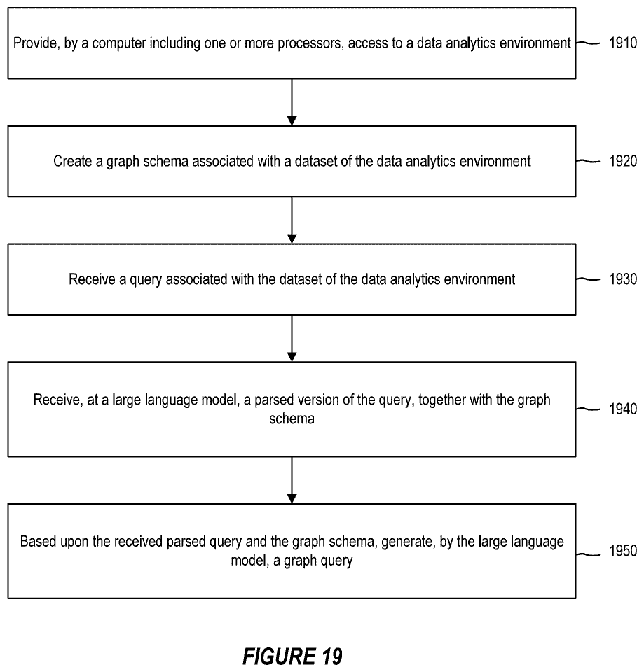

FIG. 19 is a flowchart of a method for augmenting large language models with graph knowledge generated by universal modelling of datasets, in accordance with an embodiment.

In accordance with an embodiment, at step 1910, the method can provide, by a computer including one or more processors, access to a data analytics environment.

In accordance with an embodiment, at step 1920, the method can create a graph schema associated with a dataset of the data analytics environment.

In accordance with an embodiment, at step 1930, the method can receive a query associated with the dataset of the data analytics environment.

In accordance with an embodiment, at step 1940, the method can receive, at a large language model, a parsed version of the query, together with the graph schema.

In accordance with an embodiment, at step 1950, the method can, based upon the received parsed query and the graph schema, generate, by the large language model, a graph query.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for augmenting large language models with graph knowledge generated by universal modelling of datasets, comprising:
a computer including one or more processors, that provides access to a data analytics environment; and
wherein a graph schema associated with a dataset of the data analytics environment is created;
wherein a query associated with the dataset of the data analytics environment is received;
wherein a parsed version of the query, together with the graph schema, are received at a large language model; and
wherein, based upon the received parsed query and the graph schema, the large language model generates a graph query.

2. The system of claim 1, wherein the dataset comprises a schema comprising one of a relational schema and a start schema.

3. The system of claim 2, wherein the generated graph query is run against a graph database.

4. The system of claim 3, wherein results of the generated graph query being run against the graph database are received at another large language model; and
wherein a natural language version of the results of the generated graph query being run against the database is received from the large language model.

5. The system of claim 4, wherein the received query comprises a natural language format; and
wherein the natural language version of the results of the generated graph query is caused to be displayed via one or more user interfaces.

6. The system of claim 5, wherein the received query is directed to at least a portion of a displayed data visualization associated with the dataset.

7. The system of claim 1, wherein the graph schema associated with the dataset comprises data from a plurality of other datasets.

8. A method for augmenting large language models with graph knowledge generated by universal modelling of datasets, comprising:
providing, by a computer including one or more processors, access to a data analytics environment; and
creating a graph schema associated with a dataset of the data analytics environment;
receiving a query associated with the dataset of the data analytics environment;
receiving, at a large language model, a parsed version of the query, together with the graph schema; and
based upon the received parsed query and the graph schema, generating, by the large language model, a graph query.

9. The method of claim 8, wherein the dataset comprises a schema comprising one of a relational schema and a start schema.

10. The method of claim 9, wherein the generated graph query is run against a graph database.

11. The method of claim 10, wherein results of the generated graph query being run against the graph database are received at another large language model; and
wherein a natural language version of the results of the generated graph query being run against the database is received from the large language model.

12. The method of claim 11, wherein the received query comprises a natural language format; and
wherein the natural language version of the results of the generated graph query is caused to be displayed via one or more user interfaces.

13. The method of claim 12, wherein the received query is directed to at least a portion of a displayed data visualization associated with the dataset.

14. The method of claim 8, wherein the graph schema associated with the dataset comprises data from a plurality of other datasets.

15. A non-transitory computer readable storage medium having instructions thereon for augmenting large language models with graph knowledge generated by universal modelling of datasets, which when read and executed cause a computer to perform steps comprising:
providing, by the computer, the computer including one or more processors, access to a data analytics environment; and
creating a graph schema associated with a dataset of the data analytics environment;
receiving a query associated with the dataset of the data analytics environment;
receiving, at a large language model, a parsed version of the query, together with the graph schema; and
based upon the received parsed query and the graph schema, generating, by the large language model, a graph query.

16. The non-transitory computer readable storage medium of claim 15, wherein the dataset comprises a schema comprising one of a relational schema and a start schema.

17. The non-transitory computer readable storage medium of claim 16, wherein the generated graph query is run against a graph database.

18. The non-transitory computer readable storage medium of claim 17, wherein results of the generated graph query being run against the graph database are received at another large language model; and
wherein a natural language version of the results of the generated graph query being run against the database is received from the large language model.

19. The non-transitory computer readable storage medium of claim 18, wherein the received query comprises a natural language format; and
wherein the natural language version of the results of the generated graph query is caused to be displayed via one or more user interfaces.

20. The non-transitory computer readable storage medium of claim 19, wherein the received query is directed to at least a portion of a displayed data visualization associated with the dataset.
